(19) United States
(12) Patent Application Publication
(10) Pub. No.: US 2020/0406319 A1
(43) Pub. Date: Dec. 31, 2020

(54) METHOD AND APPARATUS FOR AIR EXTRACTION IN THE AREA OF A HEATING PRESS

(71) Applicant: HARBURG-FREUDENBERGER MASCHINENBAU GMBH, Hamburg (DE)

(72) Inventors: Andreas STÖHRMANN, St. Peter-Ording (DE); Fokko ERDMANN, Scharnebeck (DE)

(21) Appl. No.: 16/970,060

(22) PCT Filed: Feb. 14, 2019
(86) PCT No.: PCT/DE2019/000036

§ 371 Date: Aug. 14, 2020

(30) Foreign Application Priority Data
Feb. 16, 2018 (DE) 10 2018 001 333.3

(51) Int. Cl. B08B 15/02; B29D 30/06

(52) U.S. Cl. CPC B08B 15/02; B08B 15/002; B29D 30/0662

(57) ABSTRACT

A method and the apparatus serve for air extraction in the area of a heating press. Extracted air is fed to at least one exhaust air treatment device. In the area of the device, the extracted air is modified in terms of at least one parameter. It is intended, in particular, to use a tire heating press as the heating press.

The invention relates to a method for air extraction in the area of a heating press, in which extracted air is fed to at least one device for acting upon the extracted air.

The invention furthermore relates to an apparatus for air extraction in the area of a heating press which is provided with a device for acting upon the extracted air.

In particular, the present invention relates to a tire heating press which is equipped with an apparatus for air extraction.

To vulcanize green tires, use is made of tire heating presses. Tire heating presses typically have a mold, into which the tires to be vulcanized are inserted. Many gases and particles are released and emitted due to the handling of the green tires and of the vulcanized tires as well as due to the vulcanization process. On the one hand, these gases are warm or even hot and, on the other hand, they furthermore often contain a number of components that are potentially damaging to the environment and/or to health.

Particularly during the process of unloading the vulcanized tires from a tire heating press, gases, particles and heat are released, and these escape from the hot, fully heated tire and form the exhaust air.

Regulations relating to employee and environmental protection make it necessary to process this exhaust air. The aim of the regulations is to minimize the stress on the user due to volatile organic compounds (VOCs), dust, aerosols and toxic gases.

According to a typical mode of operation, the tire heating presses are set up in the area of production shops, and the exhaust air rises into the area of a shop ceiling and is discharged or extracted there.

On the one hand, the method and apparatuses according to the prior art lead to toxic substances being released into the environment before being discharged or extracted.

On the other hand, there is furthermore a considerable loss of energy to the environment in the form of heat.

It is an object of the present invention to improve a method for air extraction in the area of a heating press in such a way that increased demands on environmental friendliness and/or energy consumption or energy efficiency can be satisfied.

It is another object of the present invention to improve an apparatus for air extraction of the type stated at the outset in such a way that optimized operating conditions can be achieved.

According to the invention, the objects stated above are achieved by an apparatus for air extraction as claimed in a patent claim 1, a heating press as claimed in patent claim 12, and a method for air extraction as claimed in patent claim 13.

For this purpose, an apparatus according to the invention for air extraction in the area of a tire heating press has at least one extraction device, which is connected, in each case via at least one extraction line, designed as a discharge pipe for example, to at least one air delivery device.

The air delivery device is embodied as a fan/blower or as a pump, for example, by means of which a vacuum can be produced in the area of the extraction device.

The extraction device has at least one extraction opening, into which the ambient air in the area of the at least one extraction opening can be sucked in by the vacuum produced with the aid of the air delivery device.

The exhaust air sucked into the at least one extraction opening of an extraction device can be carried into the area of at least one exhaust air treatment device with the aid of the at least one extraction line.

According to the invention, the exhaust air treatment device preferably has at least one filter and/or at least one heat exchanger.

In one embodiment of the invention, the apparatus for air extraction in the area of a heating press has at least two exhaust air treatment devices, each of which has at least one filter and/or at least one heat exchanger.

The heat exchanger is preferably designed as a finned tube heat exchanger or a coil heat exchanger.

It is possible for the at least one exhaust air treatment device to be arranged either upstream or downstream of the at least one air delivery device, relative to the direction of flow of the exhaust air.

In a particularly preferred embodiment of the invention, the filter is arranged upstream of the air delivery device, relative to the direction of flow of the exhaust air, and therefore the exhaust air is sucked through the filter.

According to the invention, consideration is also given especially to arranging at least one extraction device in the area of each of a plurality of tire heating presses or double tire heating presses, wherein said devices are connected via in each case at least one extraction line to at least one air delivery device and at least one exhaust air treatment device.

According to the invention, consideration is given both to assigning at least one air delivery device and at least one exhaust air treatment device individually to each tire heating press or double tire heating press, and to installing at least one central air delivery device and/or at least one central exhaust air treatment device for a plurality of tire heating presses and/or double tire heating presses.

According to the invention, consideration is also given to combining individual assignment of at least one air delivery device and/or at least one exhaust air treatment device to in each case at least one tire heating press or double tire heating press with the central arrangement of at least one air delivery device and/or one exhaust air treatment device for a plurality of tire heating presses and/or double tire heating presses.

Arranged upstream of the at least one air delivery device in the direction of flow there is, for each connected tire heating press, at least one controllable flap within the at least one extraction line assigned to the respective tire heating press.

With the aid of the flap, the respective extraction line can be closed and opened completely or gradually.

In a preferred embodiment of the invention, the flap is connected to a control unit by means of which the degree of opening of the flap can be controlled.

In one embodiment of the invention, the control unit for controlling the at least one flap assigned to the respective tire heating press is arranged in the respective tire heating press.

In a particularly preferred embodiment of the invention, the flap can be controlled in dependence on the production steps that can be carried out with the aid of the respectively assigned tire heating press.

In a preferred embodiment of the invention, the flap can be actuated in such a way, or the alignment of the flap within the respective extraction line can be adjusted in such a way, that an opening of the extraction line by about 0%, 30%, 50%, 70% or about 100% can be achieved.

With the aid of an embodiment according to the invention of an apparatus for air extraction in the area of a heating press, the volume flow of the extracted exhaust air can thus be specified in dependence on the delivery rate of the respective at least one air delivery device by controlling the opening of the assigned flap.

Taking into account, according to the invention, the respective process steps carried out, an increased concentration of gases, particles and thermal energy in the exhaust air can thereby be achieved, and therefore the efficiency of exhaust air treatment is improved.

In particular, an increased efficiency of thermal energy recovery is achieved.

In one embodiment according to the invention of an apparatus for air extraction in the area of a heating press, the at least one extraction device is designed as an extraction hood, which, as a particularly preferred option, is arranged above an assigned tire heating press.

In one embodiment of the invention, at least one extraction device has at least one extraction opening, which is designed as an extraction slot. In one preferred embodiment of the invention, the extraction slot is downwardly open.

In a particularly preferred embodiment of the invention, the extraction device designed as an extraction hood has an extraction opening which is designed as an extraction slot running around the outside on the lower side of the extraction device.

In another preferred embodiment of the invention, a multiplicity of extraction openings is arranged on the lower side of the extraction device, and, as a particularly preferred option, these are arranged in a uniformly distributed manner in an area running around the outside.

For this purpose, the extraction hood is of double-walled design, with the result that the area arranged between the walls of the extraction hood serves as a guide structure for the extracted air.

By virtue of the arrangement of the at least one extraction opening in a peripheral area at the edge on the lower side of the extraction device, an intensified extraction effect can be achieved in these areas, with the result that escape of toxic gases contained in the exhaust air or of hot gas into the area of the ambient air or shop air is effectively prevented or at least significantly reduced.

In another embodiment of the invention, at least one extraction device, by means of which the exhaust air can be extracted directly in the area of the opening of the heating press, is arranged in the area of the tire heating press elements holding or surrounding the tire molds.

In a preferred embodiment of the invention, at least one extraction device is arranged both on the side of the container facing the opening of the heating press and on the side of the mold pressure plate facing the opening of the heating press.

The extraction devices connected directly to the tire heating press are preferably designed as pipes running around the outer edge of the respective component and having extraction openings distributed along the circumference of the component or in the longitudinal direction of the extraction device.

In another embodiment according to the invention of an apparatus for air extraction in the area of a heating press, at least one additional extraction device is provided.

Here, the at least one additional extraction device is preferably arranged in the area of the deposition surface for tires just removed from the heating press and/or in the area of a conveyor belt, on which tires that have already cooled somewhat are conveyed away from the heating press.

In one embodiment of the invention, the delivery rate of the at least one air delivery device assigned to at least one tire heating press is controllable.

In a preferred embodiment of the invention, the delivery rate of the at least one air delivery device can be controlled in dependence on the production cycle of the at least one assigned tire heating press.

The control of the delivery rate of the at least one air delivery device is achieved by means of frequency control, for example.

According to one embodiment of the invention, the extraction capacity at one extraction device is determined at least partly by the dimensioning of the extraction line connected to the extraction device.

In particular, the extraction capacity is also specified in such a way that the surface temperature of the heating press, although lowered, is not reduced too much.

In one embodiment of the invention, the power consumption of the overall system can be controlled in accordance with demand.

In one embodiment of the invention, said embodiment has at least one pressure sensor and/or pressure switch and/or temperature sensor combined with a suitable control unit for the closed-loop and/or open-loop control of the capacity of the exhaust air system.

To further increase the efficiency of the system, it is possible in one embodiment of the invention for the waste heat to be used by means of a heat pump for other processes, e.g. for vulcanization, preparation of hot water and/or heating of buildings.

The apparatus according to the invention for air extraction is preferably arranged in the area of a shop wall or of a shop ceiling or of a shop floor.

According to the invention, consideration is furthermore also given to a heating press having an apparatus according to the invention for air extraction as at least one component.

In at least one variant, the method according to the invention for air extraction in the area of a heating press uses existing data on the quantity of emitted heated gases, particles and compounds as a function of time during all the method steps that can be carried out in the production cycle with the aid of a tire heating press in order to increase the efficiency of exhaust air treatment and/or heat recovery from the exhaust air.

Here, the production cycle comprises, for example, the method steps of preheating/heating the tire heating press, loading the tire heating press, closing the tire heating press, vulcanizing the tire, opening the tire heating press and unloading the tire heating press.

The duration of a production cycle is about 12 minutes, wherein the main quantities of exhaust gases are formed and released in a time window of about 25% of the production cycle.

Often, most of the formation of fumes and/or exhaust gases takes place in the first two to four minutes of a production cycle.

According to one variant embodiment of the method according to the invention for air extraction in the area of a heating press, the flap assigned to a tire heating press and/or the delivery rate of the air delivery device assigned to a tire heating press can be increasingly opened (flap) or raised (delivery rate) as the quantity of exhaust gas increases, and can be increasingly closed (flap) or reduced (delivery rate) as the quantity of exhaust gas decreases.

In one variant embodiment, a method according to the invention for air extraction in the area of a heating press comprises at least the following steps:
1. producing an air flow by the operation of an air delivery device,
2. extracting air by means of an extraction device in the area of a heating press,
3. reading out/recognizing the production step currently being carried out by a tire heating press and/or the temporal position in the production cycle,
4. generating the control data for the adjustment of the flap position which are required depending on the production step currently being carried out by a tire heating press and/or depending on the temporal position in the production cycle,
5. controlling a flap assigned to the tire heating press in the area of the extraction line and adjusting the degree of opening of the extraction line in the area of the flap in accordance with the flap position determined in step 3,
6. using a filter to filter the exhaust air drawn in by at least one extraction device, and/or
7. recovering thermal energy from the exhaust air with the aid of at least one heat exchanger.

Method steps 1, 2, 6 and 7 are independent in terms of time from method steps 3, 4 and 5 and take place in a substantially continuous manner.

In steps 3 and 4, it is additionally or alternatively also possible, according to the invention, for the purpose of controlling the flap, to perform control of the air delivery device in order to control the delivery line in dependence on the production step currently being carried out by a tire heating press and/or on the temporal position in the production cycle.

In method step 3, sensor data, in particular pressure and/or temperature data from corresponding sensors, are read out and evaluated, and/or the temporal position in the production cycle and/or the method step currently being carried out in the production cycle are/is read out from a control unit of the respective tire heating press.

As a particular preference, a method according to the invention for air extraction in the area of a heating press uses an apparatus according to the invention for air extraction in the area of a heating press.

According to the invention, consideration is also given to performing the open-loop control and/or closed-loop control of the at least one flap and/or of the delivery rate of the at least one air delivery device in dependence on the tire types to be produced since the quantity of exhaust gases and the time at which the exhaust gases arise in the respective production cycle may differ depending on the type of tire.

Through the superposition of the exhaust gas flows of the individual heating presses in a system having a plurality of heating presses and through the offsetting of the respective production cycles, it is possible, in accordance with the method according to the invention, for a relatively uniform overall exhaust gas/exhaust air flow to be produced.

By means of the method according to the invention for air extraction in the area of a heating press, the quantity of exhaust air is reduced and, as a result, the concentration of pollutants and of thermal energy from the exhaust gas in the exhaust air is increased.

In one embodiment of the invention, the energy supplied by the heat exchanger is used to heat fresh air fed to the production shop. One aim here is, for instance, a temperature range of 25° C. to 27° C. in the area of the shop air.

In the area of tropical regions or regions with a warm climate, the energy supplied by the heat exchanger can be used to operate an air conditioning system. According to one embodiment of the invention, direct integration of the heat pump into an air conditioning system is likewise envisaged.

Illustrative embodiments of the invention are illustrated schematically in the drawing. In the drawing:

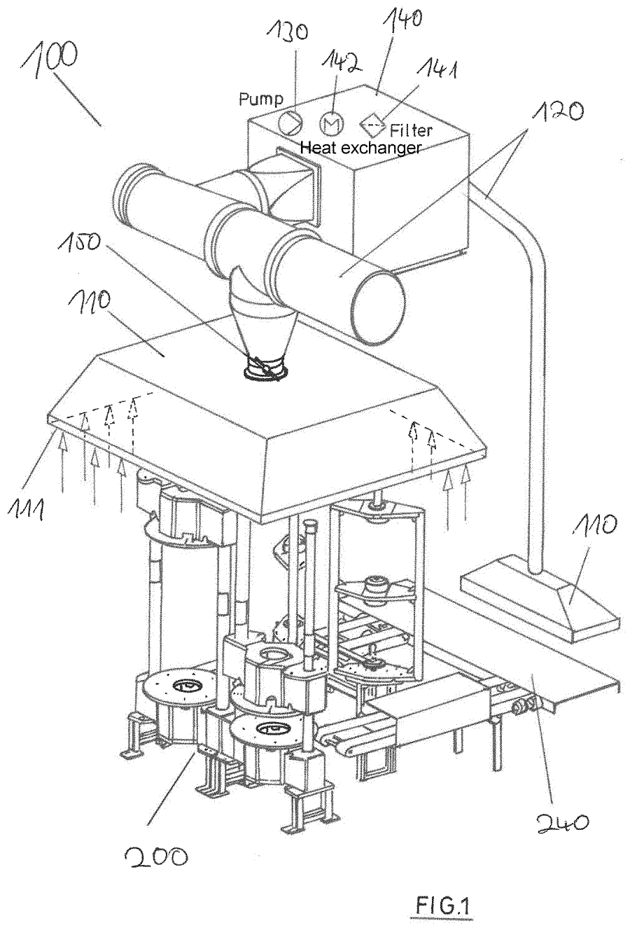

FIG. 1 shows a schematic illustration relating to the implementation of air extraction in the area of a tire heating press,

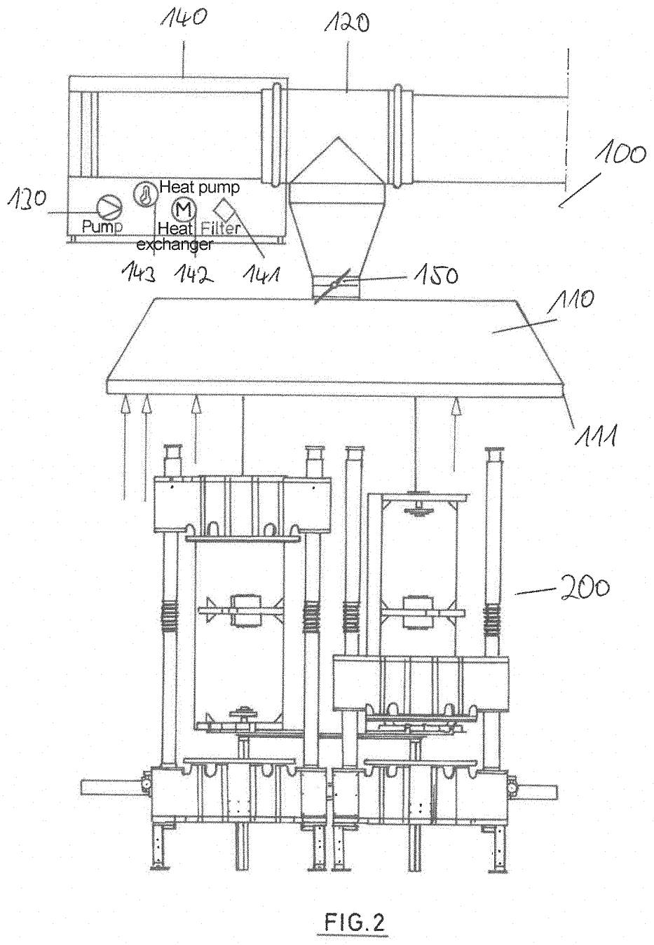

FIG. 2 shows another design implementation of air extraction in the area of a heating press,

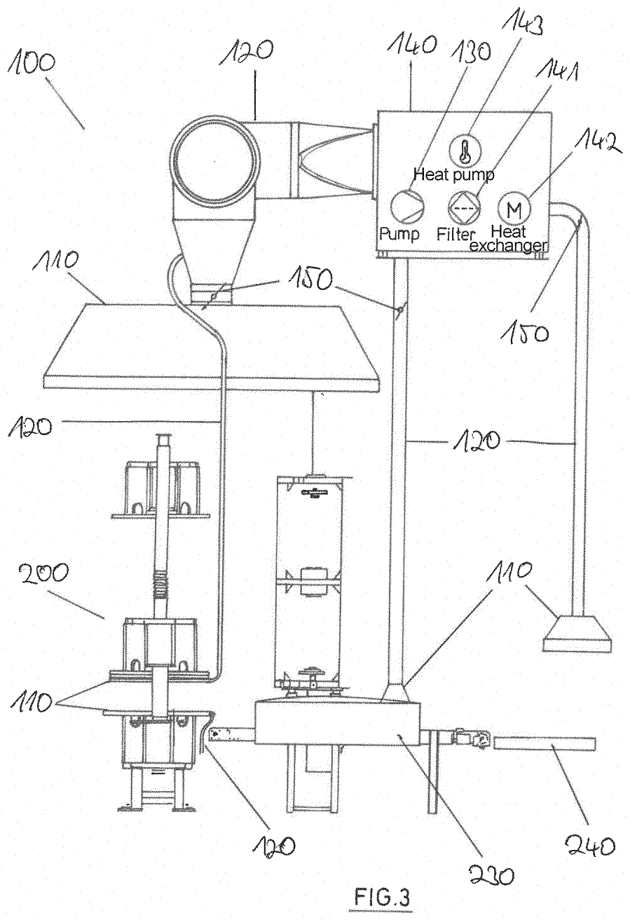

FIG. 3 shows an additionally modified design principle, and

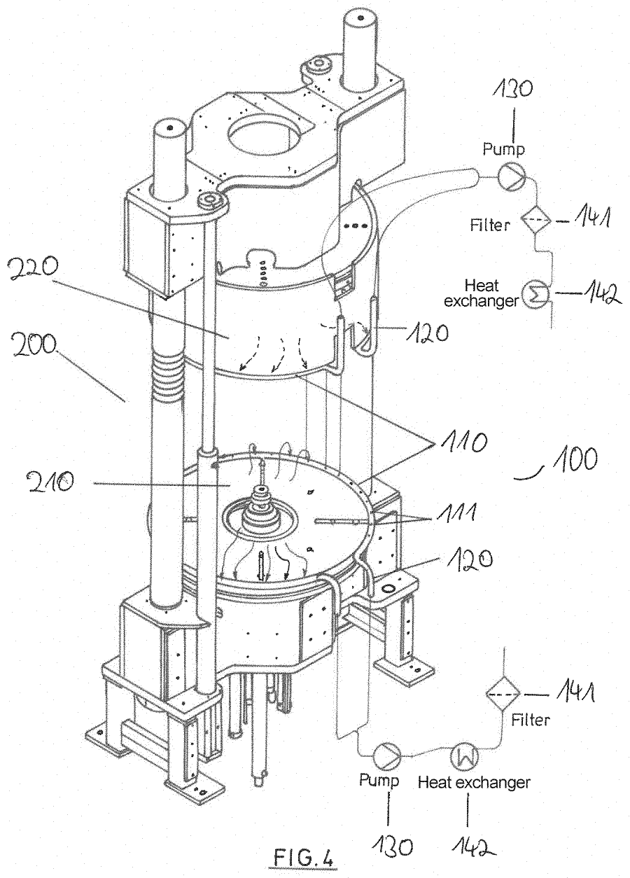

FIG. 4 shows an embodiment for carrying out extraction directly at the tire heating press.

According to the embodiment, illustrated in perspective in FIG. 1, of an apparatus according to the invention for air extraction (100), extraction takes place above and/or adjacent to or behind a tire heating press (200). The tire heating press (200) is designed as a double tire heating press.

The apparatus for air extraction (100) has two extraction devices (110), which are designed as extraction hoods and are each connected via extraction lines (120) to an air delivery device (130) designed as a pump.

Arranged in the area of each of the extraction devices (110), at the bottom, is an extraction opening (111), which is embodied, for example, as an extraction slot running around the outer edge of the extraction devices (110).

Arranged in the extraction line (120), in the area in which the extraction line (120) is connected to the extraction device (110) arranged centrally above the tire heating press (200), is a flap (150), wherein the extraction line (120) can be opened and closed gradually by means of the flap position within said line.

Arranged in the area of the air delivery device (130) is an exhaust air treatment device (140), which has both a filter (141) and a heat exchanger (142).

The second extraction device (110) is arranged above a conveyor belt (240) by means of which the fully vulcanized and somewhat cooled tire can be conveyed away from the tire heating press (200).

According to the embodiment in FIG. 2, extraction likewise takes place above, adjacent to or behind the tire heating press (200). Here too, control of the flap (150) can be used to adjust the quantity of air extracted.

Moreover, the embodiment, illustrated in FIG. 2, of an apparatus for air extraction (100) in the area of a heating press (200) has a heat pump (143) in the area of the exhaust air treatment device (140).

According to the embodiment, illustrated in FIG. 3, of an apparatus for air extraction (100), extraction above, adjacent to or behind the heating press (200) is likewise provided. For this purpose, the apparatus for air extraction (100) has five extraction devices (110).

Two extraction devices (110) are furthermore arranged centrally above the tire heating press (200) and above the conveyor belt (240). An additional extraction device (110) is arranged above the deposition surface (230) on which the fully vulcanized tire is temporarily stored for cooling before being conveyed on the conveyor belt (240). Two additional extraction devices (110) are installed directly at the heating press (200), wherein one of the extraction devices (110) is arranged on the lower side of the tire heating press (200), in the area of the opening, and the other extraction device (110) is arranged on the upper side of the tire heating press (200), in the area of the opening.

All the extraction devices (110) are connected via extraction lines (120) to at least one air delivery device (130). A flap (150) is arranged in the area of each of three of the extraction lines (120).

In one embodiment of the invention, the various flaps (150) are controlled in accordance with the production step currently being carried out or the production steps currently being carried out, so that more or less air is extracted, depending on the local occurrence of exhaust gas in the corresponding area of the tire heating press (200).

If a tire is currently being vulcanized or if the respective tire heating press (200) is subsequently opened, then, in a variant according to the invention of the method and of the apparatus, the flap (150) assigned to the extraction device (110) arranged centrally above the tire heating press (200) is opened wide or to the maximum in order to maximize the local extraction capacity.

If the vulcanized tire is then loaded onto the deposition surface (230), the flap (150) assigned to the extraction device (110) arranged centrally above the tire heating press (200) is closed somewhat further, and the flap (150) assigned to the extraction device (110) arranged above the deposition surface (230) is opened further.

If the vulcanized tire is then loaded onto the conveyor belt (240), the flap (150) assigned to the extraction device (110) arranged centrally above the tire heating press (200) may be closed somewhat further, and the flap (150) assigned to the extraction device (110) arranged above the deposition surface (230) is closed again, and the flap (150) assigned to the extraction device (110) arranged above the conveyor belt (240) is opened wide.

Once the vulcanized tire has been conveyed away with the aid of the conveyor belt (240), the flap (150) assigned to the extraction device (110) arranged above the conveyor belt (240) is closed again.

In conjunction with control of the flap positions, demand-dependent control of the delivery rate of the air delivery device (130) is implemented in one embodiment of the invention.

FIG. 4 illustrates, in a perspective detail view, extraction directly at the tire heating press (200) when using two air delivery devices (130), each designed as a pump, as well as an associated filter (141) and a heat exchanger (142).

An extraction device (110) running around in a ring shape is arranged in the area of the lower end of the container (220) on the upper part of the tire heating press (200). An extraction device (110) running around in a ring shape is arranged in the area of the mold pressure plate (210) on the lower part of the tire heating press (200).

Along their extent, the extraction devices (110) running around in a ring shape have a multiplicity of extraction openings (111), into which the exhaust air is sucked.

1-15. (canceled)

16. An apparatus for air extraction in an area of a heating press, comprising: at least one extraction device; at least one extraction line; at least one air delivery device; at least one exhaust air treatment device; at least one control unit, wherein the extraction device has at least one extraction opening; and at least one flap arranged in an area of the at least one extraction line, the at least one flap being adjustable by the control unit so that the at least one extraction line is completely and/or gradually closeable and openable.

17. The apparatus according to claim 16, wherein the at least one exhaust air treatment device includes at least one filter.

18. The apparatus according to claim 16, wherein the at least one exhaust air treatment device includes at least one heat exchanger.

19. The apparatus according to claim 16, wherein the at least one extraction device includes a plurality of extraction devices that are each assigned individually to a respective heating press and arranged in an area of the respective heating press.

20. The apparatus according to claim 16, wherein the at least one extraction device is an extraction hood.

21. The apparatus according to claim 16, wherein the at least one extraction device has the at least one extraction opening arranged in an outer area in a lower area of the extraction device.

22. The apparatus according to claim 16, wherein the at least one extraction opening is an extraction slot.

23. The apparatus according to claim 19, wherein the at least one control unit is operatively configured so that extraction capacity at various of the extraction devices assigned to a heating press is subjected individually to open-loop and/or closed-loop control by controlling a plurality of the flaps and/or controlling a delivery rate of the at least one air delivery device.

24. The apparatus according to claim 23, wherein the individual extraction capacity of the extraction devices assigned to a heating press is subjected to open-loop and/or closed-loop control in dependence on a production step that is being carried out currently and/or as a next step with the heating press.

25. The apparatus according to claim 16, further comprising at least one pressure sensor and/or at least one temperature sensor in communication with the control unit, the control unit being operative to evaluate measurement data from the pressure sensor and/or temperature sensor to determine a production step currently being carried out with the heating press and/or a current demand for extraction capacity at the at least one extraction device.

26. The apparatus according to claim 16, wherein the heating press is a tire heating press or a double tire heating press.

27. A heating press for vulcanizing tires, comprising an apparatus for air extraction according to claim 16.

28. A method for air extraction in an area of a heating press, comprising the steps of: extracting exhaust air, composed of exhaust gases and air, with an air delivery device in the area of the heating press; subjecting the exhaust air to at least one exhaust air treatment; and, controlling an extraction capacity in dependence on a production step that is being carried out with the heating press.

29. The method according to claim 28, wherein the exhaust air treatment includes recovering thermal energy present in the exhaust air.

30. The method according to claim 28, including using an apparatus for air extraction in the area of the heating press, which apparatus comprises: at least one extraction device; at least one extraction line; at least one air delivery device; at least one exhaust air treatment device; at least one control unit, wherein the extraction device has at least one extraction opening; and at least one flap arranged in an area of the at least one extraction line, the at least one flap being adjustable by the control unit so that the at least one extraction line is completely and/or gradually closeable and openable.
